(19) United States
(12) Patent Application Publication
(10) Pub. No.: US 2009/0013164 A1
(43) Pub. Date: Jan. 8, 2009

(54) Computer system and method of using power button to switch from one BIOS to another

(75) Inventors: An-Sheng Huang, Taipei City (TW); Shih-An Pai, Taipei City (TW)

Correspondence Address: Joe McKinney Muncy, PO Box 1364, Fairfax, VA, 22038-1364, US

(73) Assignee: INVENTEC CORPORATION

(21) Appl. No.: 11/822,497

(22) Filed: Jul. 6, 2007

(51) Int. Cl. G06F 9/00

(52) U.S. Cl. 713/2

(57) ABSTRACT

A computer system, using a power button to switch from one BIOS to another, includes a power button, a detection device and a switch circuit. The power button is electrically coupled to the computer system. The detection device is electrically coupled to the power button, and outputs a switch signal and a boot signal when the power button is continuously pushed for a switch time value, in which the boot signal is used to execute a boot procedure in the computer system. The switch circuit is electrically coupled to the detection device, and switches from a first BIOS to a second BIOS used for the boot procedure, in accordance with the switch signal. A method of using a power button to switch from one BIOS to another is also disclosed.

### BACKGROUND

1. Field of Invention

The present invention relates to a computer system and method of switching from one BIOS to another. More particularly, the present invention relates to a computer system and method of using a power button to switch from one BIOS to another.

2. Description of Related Art

Basic Input Output System (BIOS) in a computer system configures communications between a control chip and other chips on a main board, and configures the setting for the boot procedure, so that users can complete the boot procedure to enter an operating system. As described above, BIOS is very important for the computer system. Therefore, the boot procedure would be seriously affected if the BIOS is damaged by viruses or improper updating.

A method for solving the foregoing problem is to divide the BIOS read only memory (ROM), which stores the BIOS data, into two sections. One section is used for the boot procedure, and the other is used for the backup. Then a user can switch between two sections with the assistant software. However, the foregoing method usually requires that the data of the starting area of the BIOS ROM is complete, so the computer system can start and execute the BIOS switch process. If the data of the starting area of the BIOS ROM is entirely damaged, the BIOS switch process cannot be executed.

Furthermore, there are other conventional methods for solving the foregoing problem. For example, a jumper wire is used for cutting on the action of restoring the default BIOS data on the main board, such that the BIOS can be updated. However, the users still have to obtain the BIOS updating data themselves. Therefore, this method is inconvenient and complicated for the users.

For the foregoing reasons, there is a need to provide an easier method of switching between the two reserved memory sections of the BIOS ROM, such that the users can easily resolve all abnormal boot procedures that occur as a result of the BIOS data being damaged, and can complete the rescue procedure as well.

### SUMMARY

In accordance with one embodiment of the present invention, a computer system using a power button to switch from one BIOS to another is provided. The computer system includes a power button, a detection device and a switch circuit. The power button is electrically coupled to the computer system. The detection device is electrically coupled to the power button, and outputs a switch signal and a boot signal when the power button is pushed continuously for a switch time value, in which the boot signal is used to execute a boot procedure in the computer system. The switch circuit is electrically coupled to the detection device, and switches from a first BIOS to a second BIOS used for the boot procedure, according to the switch signal.

In accordance with another embodiment of the present invention, a method of using a power button to switch from one BIOS to another is provided. The method includes the steps of pushing a power button of a computer system; detecting the power button being pushed; determining if the power button being pushed continuously for a switch time value; outputting a switch signal and a boot signal when the power button being pushed continuously for the switch time, in which the boot signal is used to execute a boot procedure in the computer system; and switching from a first BIOS to a second BIOS used for the boot procedure according to the switch signal.

For the foregoing embodiment of the present invention, the computer system and method of using a power button to switch from one BIOS to another can let users easily switch between the damaged BIOS and the backup BIOS, and only use the power button to execute the BIOS switch process, to complete the rescue process, when the major part of BIOS for the boot procedure is entirely damaged; that is, when the backup program of the computer system is damaged, or all of the data in the BIOS has disappeared or become disordered. Moreover, an additional button or software is not necessary, and the cost for the rescue process can be saved.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the preferred embodiment, with reference made to the accompanying drawings as follows:

FIG. 1 shows the computer system according to one embodiment of the present invention;

FIG. 2 shows the computer system according to another embodiment of the present invention; and

FIG. 3 shows a flow chart of a method of using a power button to switch from one BIOS to another according to one embodiment of the present invention.

### DESCRIPTION OF THE PREFERRED EMBODIMENTS

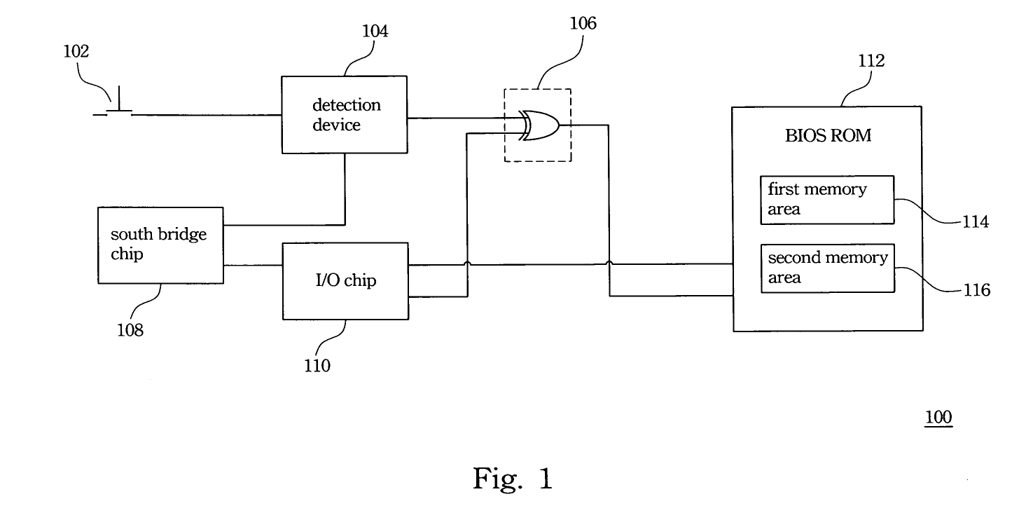

FIG. 1 shows the computer system according to one embodiment of the present invention. The computer system includes a power button 102, a detection device 104, a switch circuit 106, a south bridge chip 108, an I/O chip 110 and a BIOS read only memory (ROM) 112. The detection device 104 is electrically coupled to the power button 102 and detects the time values of the power button 102 being pushed. The detection device 104 outputs a switch signal, a boot signal or a shutdown signal, in which the boot signal is used to execute a boot procedure in the computer system, and the shutdown signal is used to execute a shutdown procedure in the computer system. The detection device 104 can be a programmable array logic (PAL) device, and designers can compile or modify the codes of the programmable array logic device to add the additional detection function, to output the detection signals by the programmable array logic device. The switch circuit 106 is electrically coupled to the detection device 104 and switches from a first BIOS to a second BIOS used for the boot procedure according to the switch signal, in which the switch circuit 106 can be an XOR logic gate in this embodiment.

The south bridge chip 108 is electrically coupled to the detection device 104 and receives the boot signal or the shutdown signal output from the detection device 104 to output a command signal. The I/O chip 110, such as Super I/O chip, is electrically coupled to the south bridge chip 108 and receives the command signal output from the south bridge chip 108, so as to execute the boot procedure or the shutdown procedure. The BIOS ROM 112 is electrically coupled to the switch circuit 106 and the I/O chip 110, and has a first memory area 114 for storing the first BIOS and a second memory area 116 for storing the second BIOS.

When the power button 102 is pushed continuously for less than a predetermined time value, such as 4 seconds, the detection device 104 outputs the boot signal to the south bridge chip 108, and the south bridge chip 108 transmits the relevant boot command signals to the I/O chip 110, so that the I/O chip 110 reads the first BIOS stored in the first memory area 114 of the BIOS ROM 112 to execute the boot procedure.

When the power button 102 is pushed continuously for the predetermined time value, such as 4 seconds, the detection device 104 outputs the shutdown signal to the south bridge chip 108, and the south bridge chip 108 transmits the relevant shutdown command signals to the I/O chip 110, so as to execute the shutdown procedure.

When the power button 102 is pushed continuously for a switch time value, such as 8 seconds, the detection device 104 outputs the boot signal to the south bridge chip 108, and outputs the switch signal to the switch circuit 106, i.e. XOR logic gate. At the moment, the XOR logic gate switches from the first memory area 114 to the second memory area 116 of the BIOS ROM, according to the switch signal output from the detection device 104, so that the BIOS stored in the first memory area 114 can be switched to the BIOS stored in the second memory area 116 for the I/O chip 110 to read and execute the boot procedure as well.

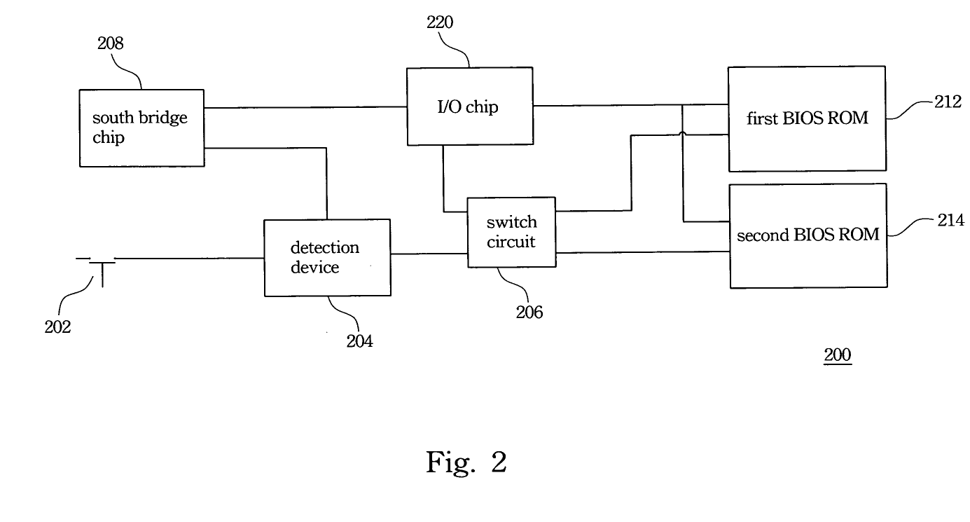

FIG. 2 shows the computer system according to another embodiment of the present invention. The computer system includes a power button 202, a detection device 204, a switch circuit 206, a south bridge chip 208, an I/O chip 210, a first BIOS ROM 212 and a second BIOS ROM 214, in which the connection and the operation of the power button 202, the detection device 204, the south bridge chip 208 and the I/O chip 210 are the same as the embodiment shown in FIG. 1. For this embodiment, the detection device 204 can also be a programmable array logic (PAL) device, and the switch circuit 206 can be logic circuit. Additionally, the first BIOS ROM 212 and the second BIOS ROM 214 are respectively coupled to both the switch circuit 206 and the I/O chip 210, and stores the first BIOS and the second BIOS, respectively.

When the power button 202 is pushed continuously for less than the predetermined time value, such as 4 seconds, the detection device 204 outputs the boot signal to the south bridge chip 208, and the south bridge chip 208 transmits the relevant boot command signals to the I/O chip 210, so that the I/O chip 210 reads the first BIOS stored in the first BIOS ROM 212 to execute the boot procedure.

When the power button 202 is pushed continuously for the predetermined time value, such as 4 seconds, the detection device 204 outputs the shutdown signal to the south bridge chip 208, and the south bridge chip 208 transmits the relevant shutdown command signals to the I/O chip 210, so as to execute the shutdown procedure.

When the power button 202 is pushed continuously for the switch time value, such as 8 seconds, the detection device 204 outputs the boot signal to the south bridge chip 208, and outputs the switch signal to the switch circuit 206, i.e. logic circuit. At the moment, the logic circuit switches from the first BIOS ROM 212 to the second BIOS ROM 214, according to the switch signal output from the detection device 204, so that the first BIOS stored in the first BIOS ROM 212 can be switched to the second BIOS stored in the second BIOS ROM 214 for the I/O chip 210 to read and execute the boot procedure as well. As a result, the BIOS switch process in the computer system can be easily completed by using the power button.

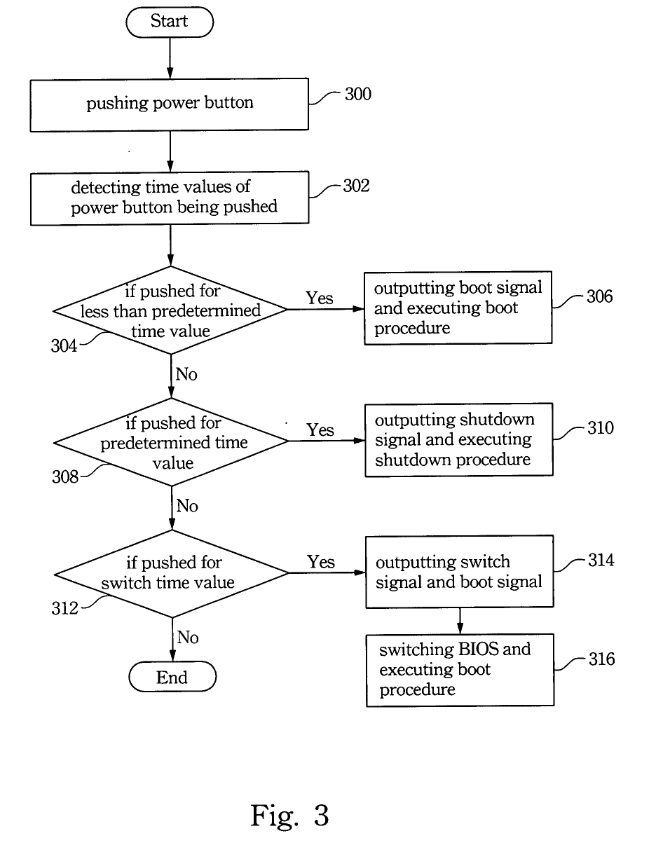

FIG. 3 shows a flow chart of a method of using a power button to switch between the two BIOS according to one embodiment of the present invention. At first, a power button of a computer system is pushed by a user (step 300). Then, a detection device detects the time values of the power button being pushed (step 302). Sequentially, whether or not the power button is pushed continuously for less than a predetermined time value, such as 4 seconds, is determined (step 304). If the power button is pushed continuously for less than the predetermined time value, the boot signal is output for the computer system to execute the boot procedure (step 306). If not, whether or not the power button is pushed continuously for the predetermined time value is determined (step 308).

If the power button is pushed continuously for the predetermined time value, the shutdown signal is output for the computer system and the shutdown procedure is executed (step 310). If not, whether or not the power button is pushed continuously for the switch time value, such as 8 seconds, is determined (step 312), in which the predetermined time value is less than the switch time value.

If the power button is pushed continuously for the switch time value, the switch signal and the boot signal are both output (step 314). Then, the first BIOS is switched to the second BIOS according to the switch signal, and the boot procedure is executed according to the boot signal (step 316).

For the foregoing embodiment of the present invention, the computer system and the method of using a power button to switch between the two BIOS can let users easily switch from the damaged BIOS to the backup BIOS, and let the users only use the power button to execute the BIOS switch process, to complete the rescue process, when the major part of the BIOS for the boot procedure is entirely damaged; that is, when the backup program of the computer system is damaged, or all of the data in the BIOS has disappeared or become disordered. Moreover, an additional button or software is not necessary, and the cost for the rescue process can be saved.

As is understood by a person skilled in the art, the foregoing preferred embodiments of the present invention are illustrative of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A computer system using a power button to switch from one BIOS to another, comprising:
a power button electrically coupled to the computer system;
a detection device electrically coupled to the power button, the detection device outputting a switch signal and a boot signal when the power button being pushed continuously for a switch time value, wherein the boot signal is used to execute a boot procedure in the computer system; and
a switch circuit electrically coupled to the detection device and switching from a first BIOS to a second BIOS used for the boot procedure according to the switch signal.

2. The computer system as claimed in claim 1, wherein when the power button is pushed continuously for a predetermined time value, the detection device outputs a shutdown signal used to execute a shutdown procedure in the computer system.

3. The computer system as claimed in claim 2, wherein when the power button is pushed continuously for less than the predetermined time value, the detection device outputs the boot signal used to execute the boot procedure in the computer system.

4. The computer system as claimed in claim 2, wherein the predetermined time value is less than the switch time value.

5. The computer system as claimed in claim 1, further comprising:
a BIOS read only memory electrically coupled to the switch circuit, the BIOS read only memory having a first memory area for storing the first BIOS and a second memory area for storing the second BIOS.

6. The computer system as claimed in claim 5, wherein the switch circuit comprises:
an XOR logic gate, the XOR logic gate switching from the first memory area to the second memory area of the BIOS read only memory according to the switch signal output from the detection device, for an I/O chip to execute the boot procedure.

7. The computer system as claimed in claim 1, further comprising:
a first BIOS read only memory and a second BIOS read only memory both electrically coupled to the switch circuit and respectively for storing the first BIOS and the second BIOS.

8. The computer system as claimed in claim 7, wherein the switch circuit comprises:
a logic circuit, the logic circuit switching from the first BIOS read only memory to the second BIOS read only memory according to the switch signal output from the detection device, for an I/O chip to execute the boot procedure.

9. The computer system as claimed in claim 1, wherein the detection device is a programmable array logic device.

10. A method of using a power button to switch from one BIOS to another, comprising the steps of:
pushing a power button of a computer system;
detecting time values of the power button being pushed;
determining if the power button being pushed continuously for a switch time value;
outputting a switch signal and a boot signal when the power button being pushed continuously for the switch time, wherein the boot signal is used to execute a boot procedure in the computer system; and
switching from a first BIOS to a second BIOS used for the boot procedure according to the switch signal.

11. The method as claimed in claim 10, further comprising the steps of:
determining if the power button being pushed continuously for a predetermined time value; and
outputting a shutdown signal used to execute a shutdown procedure in the computer system when the power button being pushed continuously for the predetermined time value.

12. The method as claimed in claim 11, further comprising the steps of:
determining if the power button being pushed continuously for less than the predetermined time value; and
outputting the boot signal used to execute the boot procedure in the computer system when the power button being pushed continuously for less than the predetermined time value.

13. The method as claimed in claim 11, wherein the predetermined time value is less than the switch time value.
